(19) United States
(12) Patent Application Publication
(10) Pub. No.: US 2019/0262704 A1
(43) Pub. Date: Aug. 29, 2019

(54) DYNAMIC LIVESTREAM SEGMENT GENERATION METHOD AND SYSTEM

(71) Applicant: Medal B.V., Naarden (NL)

(72) Inventors: Wilhelmus Wilfried Alexander de Witte, Long Beach, CA (US); Joshua Jay Lipson, Long Beach, CA (US); Zaid Deric Osama Elnasser, Long Beach, CA (US); Dexter Speller-Drews, Ontario (CA); Ali Akbari Boroumand, Sheffield (GB)

(21) Appl. No.: 15/905,895

(22) Filed: Feb. 27, 2018

(51) Int. Cl. A63F 13/25; H04L 29/06

(52) U.S. Cl. CPC A63F 13/25; H04L 67/38

(57) ABSTRACT

The present invention provides a method and system for dynamic segment generation and distribution. The method and system includes receiving a content feed including videogame gameplay, the content feed including at least one of an audio feed and a video feed. The method and system includes monitoring the content feed to detect a clip trigger, the clip trigger indicating generation of a segment, wherein the segment is a portion of the content feed. Upon clip trigger detection, the method and system includes generating a segment from the content feed by clipping a portion of the content feed in reference to the clip trigger. The method and system then includes formatting the segment and electronically distributing, to a content distribution system, either a location identifier identifying the segment or the segment itself.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### RELATED APPLICATIONS

The are no related applications.

### FIELD OF INVENTION

The disclosed technology relates generally to content generation and distribution systems and more specifically to content generation and distribution relating to livestreaming content.

### BACKGROUND

There has been a growing trend for generating and distributing gameplay content. The content is often referred to as a livestream because it is a stream of the live gameplay. The livestream can be distributed in real-time as the player is actively playing the game or can be recorded and later distributed.

Well known technologies allow for the capture of gaming activities, whether it be via an intermediate hardware game-capture device, a software game-capture module or an internal gaming platform feature. Well known technology also allows for the distribution of the captured gameplay.

Therefore, it is well established to capture and distribute gameplay using any number of suitable techniques. For example, U.S. Pat. No. 8,764,569 issued to Livestream, LLC describes multiple techniques for generating livestream broadcasts of video game activities. Where original technological intents were to generate and distribute livestream content, problems arise in the excess volume of content currently available, inhibiting the quality of livestream videos and excluding a large audience of potential viewers (who are interested in shorter versions).

Users actively engaged and focused on playing the video game are limited in livestream content management. It is problematic to provide livestream instructions while actively engaged in gameplay. Thus, the typical livestream consists of a streamer turning on the livestream broadcast or recording and then engaging in gameplay for a period of time.

One current technique for livestream distribution is to use voice commands for broadcast initiation, as described in U.S. Patent Application No. 2015/0298010 filed by Microsoft®. This technique allows for users to utilize voice commands to direct the gaming system for initiating the broadcast. This technique operates at the gaming system level for voice command recognition and content distribution. This technique eases creation of livestream content, further contributing to problems of large volumes of livestream content. This system operates at the user level, imposing hardware and software requirements on the user gaming system.

With the large volume of video game broadcasting and the volume of content available for viewing, there exists a need for a system and method to dynamically modify or otherwise parse the livestream video content for concise livestream content distribution. Moreover, there is a need for providing livestream management in a networked environment usable in a thin-client environment, reducing processing overhead on the user's system.

### BRIEF DESCRIPTION

The present invention provides a method and system for dynamic segment generation and distribution. The method and system includes receiving a content feed including videogame gameplay, the content feed including one or more of an audio feed and a video feed. The method and system includes monitoring the content feed to detect a clip trigger, the clip trigger indicating generation of a segment, wherein the segment is a portion of the content feed. Upon clip trigger detection, the method and system includes generating a segment from the content feed by clipping a portion of the content feed in reference to the clip trigger. The method and system then includes formatting the segment and electronically distributing, to a content distribution system, either a location identifier identifying the segment or the segment itself. As such, the method and system improves the quality of livestream content by dynamically generating viewable clips for distribution instead of full livestream distribution.

In one embodiment, the network location identifier may be a uniform resource locator (URL), such as a web address designating a location of either a stored or currently-being-generated livestream event.

The method and system further provides that the monitoring the content feed to detect the clip trigger includes accessing a machine learning processing engine including a trigger detection database and detecting the clip trigger using the machine learning processing engine.

Where the content feed includes the audio feed and the clip trigger is an audio trigger, the audio trigger may include one or more of: user-generated voice commands, a game generated audio clip, or background noise. Where the content feed includes the video feed and the clip trigger is a video trigger, the video trigger may include one or more of: a text display, a graphical display, or a triggering visual element.

The method and system further determines segment length based on a number varying embodiments. In one embodiment, a segment beginning time is selected as occurring at a time prior to the clip trigger detection. The time prior may be a selected time to allow introduction to the livestream sequence, such as for example thirty seconds prior in time. The segment ending time is determined and therefore the segment is formed by extracting the content feed portion between the segment beginning time and the segment ending time. In varying embodiments, the segment ending time may be determined by recognition of an end-clip voice command, a predetermined time period from the clip trigger detection, or other means.

The method and system further includes wherein the content feed is a livestream broadcast. The broadcast may be a realtime livestream broadcast, or may be a record broadcast stored in a storage location.

In further embodiments, the method and system utilizes machine learning processing to improve the clip trigger detection. The method and system includes receiving user feedback regarding the accuracy of the detection of the clip trigger and providing the feedback to a machine learning processing engine for updating a trigger detection database.

### BRIEF DESCRIPTION OF THE DRAWINGS

A better understanding of the disclosed technology will be obtained from the following detailed description of the preferred embodiments taken in conjunction with the drawings and the attached claims.

FIG. 1 illustrates one embodiment of a system for dynamic generation and distribution of livestream segments;

FIG. 2 illustrates one embodiment of a computing system providing for dynamic generation and distribution of livestream segments;

FIG. 3 illustrates another embodiment of a system for dynamic generation and distribution of livestream segments;

FIG. 4 illustrates a visual representation of a content feed;

FIGS. 5A-5F illustrate visual representations of segment generation within the content feed;

FIG. 6 illustrates a flowchart of the steps of one embodiment of method for dynamic generation and distribution of livestream segments; and.

FIG. 7 illustrates another embodiment of a system for dynamic generation and distribution of livestream segments with a split content feed.

### DETAILED DESCRIPTION

Various embodiments are described herein, both directly and inherently. However, it is understood that the described embodiments and examples are not expressly limiting in nature, instead illustrate examples of the advantageous uses of the innovative teachings herein. In general, statements made in the specification of the present application do not necessarily limit any of the various claimed inventions and it is recognized that additional embodiments and variations recognized by one or more skilled in the art are incorporated herein.

Existing livestream distribution technology produces too much content. Furthermore, users wishing to livestream content are interested in ensuring the livestream of the most important segments. While engaged in gaming operations, users are severely restricted from managing livestream controls. While described herein relative to gameplay, the dynamic clipping operations for segment generation is additionally applicable to any content feed including for example, but not limited to, a sporting event feed, a social media audio/video feed, etc.

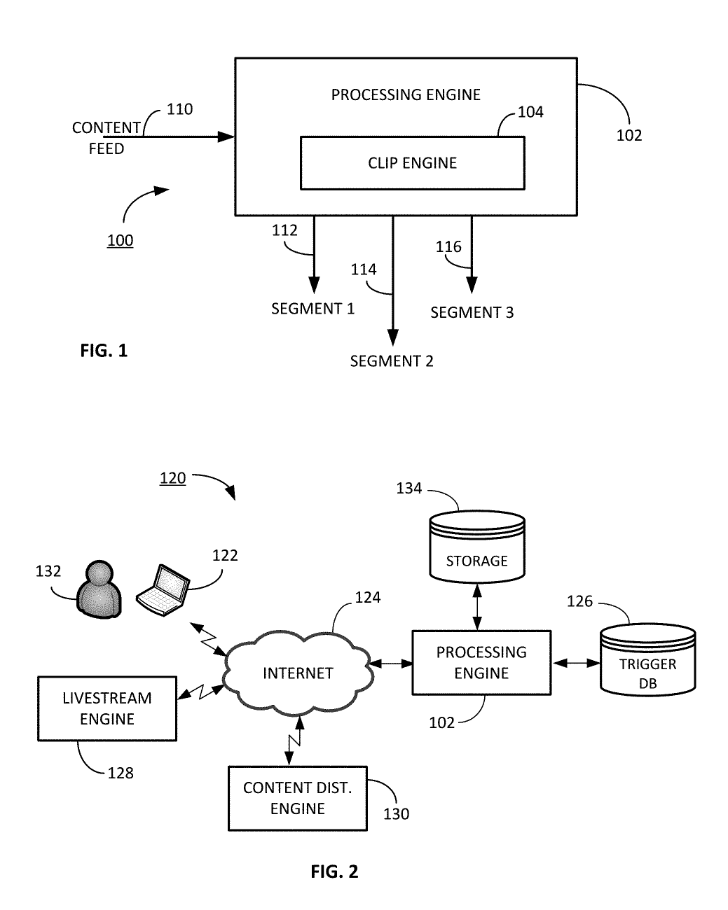

FIG. 1 illustrates a general representation of a system 100 that solves the current problems by providing for dynamic segment generation and distribution. The system 100 dynamically generates a content segment, which is a portion of the content feed. The content segment is generated by a clipping function in response to a clip trigger.

The system 100 includes a processing engine 102 that includes a clip engine 104. The processing engine 102 and the clip engine 104 may be one or more processing devices operative to perform processing operations as described herein. The engine 104 may be disposed within the engine 102, or in a distributed computing environment, such as for example accessible via a cloud computing network.

The engines 102, 104 may be centrally located or displaced in a network-computing environment. The engines 102, 104 are operative to perform various processing operations in response to executable instructions provided from a computer readable medium. The computer readable medium may be any suitable physical medium capable of having the instructions stored thereon such that engines 102, 104 are operative to receive and read instructions therefrom. The computer readable medium may be local or accessed via a network connection.

In one embodiment of operation, the engine 102 receives content feed 110. The content feed 110 may include receipt of a network address (e.g. URL) or any other form of a livestream identifier, such that the processing engine 102 retrieves livestream content. Whereas, further embodiments may include direct receipt of a livestream feed. As described in further detail below, the content feed 110 may include an ongoing livestream from a livestream distribution network, or may be received from one or more storage locations from a previously-recorded livestream.

The content feed includes video content and/or audio content. In one embodiment, the content feed includes a livestream of videogame gameplay. For example, the livestream may be received from an existing livestream distribution system, such a Twitch®, Youtube® Live, PlayStationNetwork®, Facebook® Live, or any other suitable platform.

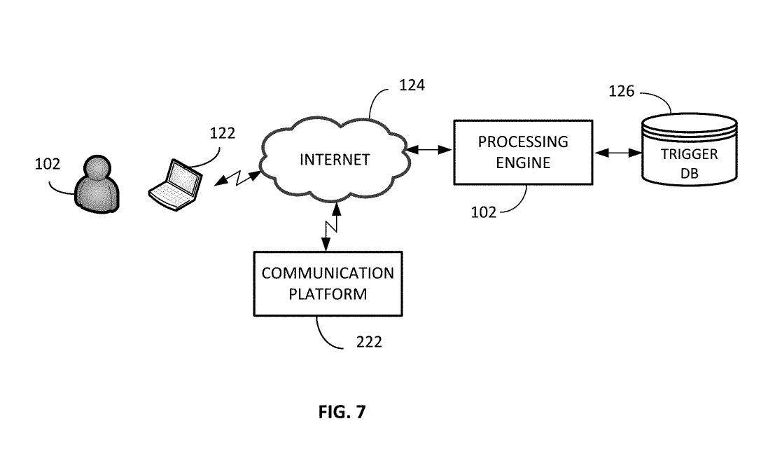

In further embodiments, the content feed may include video content from one source and audio content from another source. For example, video content may be received from a first network and the audio content is received from a second network. In one exemplary embodiment, a user may distribute audio using a group chatting application, e.g. Discord®, and the video feed is being distributed separately to a local processor, as described in further detail as to FIG. 7 below.

The processing engine 102 monitors the content feed 110 for detecting a clip trigger. Where the content feed is an audio feed, the clip trigger is an audio trigger and where the content feed is a video trigger, the clip trigger is a video trigger. Where the content feed includes both audio and video, the clip trigger may either or both audio and video.

As the processing engine 102 receives the content feed 110, a clip engine 104 operates within the processing engine 102 to generate content segments, such as segments 112, 114, and 116. It is recognized by one skilled in the art that further processing operations can be performed by the processing engine 102 and are omitted for brevity purposes only. For example, the processing engine 102 may employ audio filtering operations to improve audio feed quality, e.g. bandpass filtering to remove audio artifacts. In another example, the processing engine 102 may utilize data scraping operations relating to the content feed for application of meta data or other identifiers with the segments 112-116.

In the embodiment of an audio feed, the processing engine 102, as described in further detail below, parses out and examines the audio feed in the content feed 110. The processing engine 102 examines the audio feed to detect an audio trigger, which is a sound or sounds within the audio track(s) designating content worth capturing in a segment. In one embodiment, the audio trigger may be one or more user-generated voice commands, such as statements by the user during the livestream event, for example the user stating “clip that” to generate a clip or for example stating “screenshot that” to capture a screenshot.

The user's statement is captured in the audio feed, recognized by the processing engine 102. In another embodiment, the audio trigger may be recognition of background noise, such as a volume level within the game or an excitement level of the user. In another embodiment, the audio trigger may be a game generated audio clip, such as a designated sound or audio track found within the particular game or event of the content feed 110, for example a video game may include a unique audio sound prior to a battle scene or the emergence of a specialized (e.g. Boss) opponent. It is recognized the above examples are exemplary in nature and not expressly limiting such that an audio trigger may be any sound on the audio track that when detected initiates segment generation.

In the embodiment where the clip trigger is a video trigger, the processing engine 102 monitors the video feed for clip trigger detection. The video trigger may include a text display, for example the processing engine 102 using optical character recognition (OCR). For example, the text display may include known displays for specific feeds, such as a game that includes a common score screen. The video trigger may include a graphical display, such as a logo or recognizable graphical element that indicates segment generation, similar to the text display but maybe including stylized lettering making OCR not possible, or unique graphic elements particular to a specific game. The video trigger could also include a triggering visual element, which may be a predetermined element embedded within the video feed that automatically triggers segment generation. By way of example, if a user gave a voice command to segment generation and the video feed is being monitored, a local processor may recognize the voice command and instead of generating a segment, inserts a predetermined image within the video feed to trigger clipping operations. The video trigger may include variations and the above examples are exemplary in nature and not expressly limiting.

Within the processing engine 102, upon detecting the audio trigger, the clip engine 104 clips the corresponding segment of the content feed 110 to generate the segment 112. Varying embodiments may be utilized for segment generation, based on user preferences, system preferences, content feed 110, or any other suitable factors. For example, one embodiment may include beginning the segment by capturing audio data and video data occurring a predetermined time period before the trigger recognition. In one example, the engine 104 may begin the clip at a period of thirty seconds prior to the trigger recognition. While not expressly illustrated, the processing and/or clip engine may include a buffer or other type of memory structure to process the content feed and allow for prior-in-time content feed capture.

In another embodiment, the processing engine 102 may include audio recognition and instruction translation functionality. For example, the audio trigger may be a user-generated instruction to generate a segment and go back a set number of seconds. The processing engine 102 can then analyze the audio, determine it is an instruction and perform the corresponding instruction. By way of example, an instruction may include not only a statement to generate a segment but also indicate that the segment begins 60 seconds prior.

The length of the segment in the clipping operations can also be determined by any number of varying embodiments. For example, one technique may include a predetermined time period, such as the segment being ninety seconds in length before or after the trigger detection. For example, another technique may include user instructions within the audio trigger to end the segment, such that the audio trigger may be a two-part instruction to begin segment generation and terminate segment generation. In the example of in-game audio, the segment generation may terminate the clipping by recognition of a common sound for completing the level or when a character dies, by way of example.

In one embodiment, further content processing by the processing engine 102 may scrub out any user-generated instructions from a subsequently generated segment. For example, if the user states “clip that,” the generated segment may have the user instructions extracted from the audio.

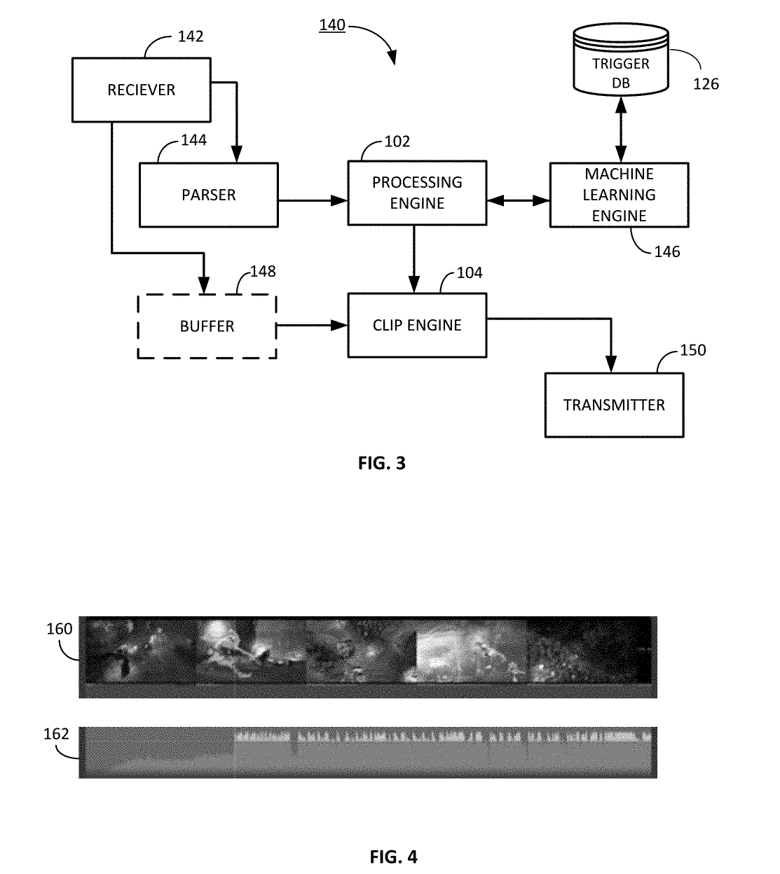

As part of the clip engine 104 and/or the processing engine 102, one embodiment includes a machine learning engine (not expressly illustrated) that further improves segment generation. As described in further detail below, such as FIG. 3, the machine learning engine assists in clip trigger detection as well as feedback relating to clip generation for improving clip trigger recognition.

For example, in one embodiment the machine learning engine may utilize TensorFlow® which is a open-source machine learning framework. The machine learning engine may engage third-party speech recognition services, as available, in a cloud computing environment, for example DeepSpeech® available from Mozilla.

Again, in the embodiment with an audio feed, the processing engine 102 continues to monitor the audio feed, generating further segments 114, 116 upon detecting further audio triggers. For example, a content feed 110 may include any number of audio triggers and subsequent segments, where FIG. 1 illustrates three segments 112-116 for illustration purposes only.

The segments are then formatted, including for example insertion of meta data or other identifier data. The segments include the audio feed and/or the video feed from the content feed 110 for the time period designated by the processing engine 102.

The segments 112-116, in one embodiment, are video files available for distribution. The distribution may be distribution of a location identifier that identifies a storage location of the segment. In one example, the segment is stored on a distribution system, the storage location referenced by a uniform resource locator (URL), where the distribution of the segment includes distribution of the URL. With URL distribution, third-parties are able to then access and view the segments by accessing the distribution system.

In another embodiment, distribution may be the distribution of segment itself including storage of the video file on a user's local storage or in a networked storage location. The distribution may also include broadcast of the video file, or any other suitable means of content distribution as recognized by one skilled in the art.

In one embodiment, the distribution may include distribution to dedicated segment generation and distribution platform. The platform may include further user interface functionalities for user community operations, content sharing, commenting, feedback, etc. The platform may further include distribution to one or more network identifiable location via any means, including a URL, to different network-connected devices, including but not limited to mobile devices, laptops, computers, etc.

As used herein, the content distribution system generally refers to any system allowing for subsequent content distribution. In addition to the embodiments noted above, a further embodiment may include local storage in a local computing or gaming device. The local storage may include storage of the segment itself and/or storage of a URL indicating a location of the segment.

FIG. 2 illustrates an embodiment of a network system 120 utilizing the processing engine 102. The system 120 includes a computing device 122 accessible to a network, such as Internet 124. The processing engine 102 is in communication with a clip trigger database 126. The system 120 further includes a livestream engine 128 and a content distribution engine 130. In one embodiment, the system 120 further includes a network storage device 134.

In this system 120, the processing engine 102, includes the clip engine (not expressly illustrated). The computer 122 may be any suitable type of computer or system generating gameplay, such as a laptop or gaming desktop computer, where a user 132 plays a videogame thereon. The computer 122 is not expressly restricted to a laptop or desktop computer, but rather is any suitable device capable of generating gameplay that can become a content stream. For example, the computer 122 can be a gaming console, a mobile phone, a televisions set-top box, a tablet computer or electronic reader, etc.

During operations, the computer 122 performs gameplay operations, where connection to the livestream engine 128 allows for livestream generation and subsequent distribution. The livestream engine 128 may be any suitable engine for generating, storing or distributing livestream content. By way of example, the engine 128 may be a proprietary gaming network associated with the gaming console or software platform run by the computer 122. For example, the user 132 can generate a livestream which is then stored on the engine 128.

The content distribution engine 130 may be part of the livestream engine 128, but may also be a unique engine. For example, the distribution engine 130 may distribute segments (e.g. segments 112-116 of FIG. 1) within its own network or may integrate or distribute segments back into the network of the livestream engine 128. In further embodiments, the distribution may include storage of the segment in a designated network storage location, e.g. network storage 134, or in a local storage such as on computer 122 and distribution of a URL or other identifier for user-access of the segment.

The trigger database 126 may be one or more storage devices operative to store data relating to the clip trigger detection. The trigger database 126 operates in conjunction with the machine learning engine (146 of FIG. 3) for aiding in the machine learning engine both detecting clip triggers and improving clip trigger detection through feedback operations.

The network storage 134 may be any suitable network storage device or devices accessible by the processing engine 102. For example, in one embodiment the storage 134 may be a cloud storage server(s).

In the system 120, the processing engine 102 receives the content feed across the network 124 from either the computer 122 or the livestream engine 128. In further embodiments, additional storage or computing resources may be between the livestream engine 128 and the computer 122, such that the content feed may be received from any suitable storage or computing resource. In the embodiment of the livestream engine 128, a network identifier may be used to indicate a storage location of the content feed.

The processing engine 102 generates content segments as described above regarding FIG. 1, including clip trigger detection. Further illustrated in FIG. 2, the trigger database 126 can be utilized to improve identification of clip triggers. For example, the trigger database 126 may include data indicating sound(s) within a particular game indicating a highly viewable portion, e.g. a concluding battle or level-up. As described in further detail below, the trigger database 126 further operates in conjunction with the machine learning engine for improving and refining clip trigger identification.

Upon generation of segments, the processing engine 102 therein electronically distributes the segments via the content distribution engine 130 across the network 124. While illustrated as a single engine 130, it is recognized that any number of engines 130 can be used for distribution. In one embodiment, the segment consists of audio and video stored in a network location with the network address being distributed across the network. As noted above, the distribution may further include distribution of the segment itself or distribution of a URL identifying the storage location of the segment.

FIG. 3 illustrates another embodiment of a system 140 for segment generation. The system 140 includes the processing engine 102, clip engine 104 and trigger database 126 as described above. The system 140 further includes a receiver 142, a parser 144, a machine learning engine 146, an optional buffer 148 and a transmitter 150.

The receiver 142 may be any suitable device or devices operative to receive the incoming content feed. The receiver 142 may passively receive the content feed or in further embodiments, retrieve the content feed from a network location. The parser 144 is one or more processing devices operative to parse the incoming content feed into at least its audio feed and video feed. The livestream may further include a data feed or data files associated therewith, such as metadata as to the content (e.g. videogame title, manufacturer, gaming platform, etc.) and to the player (e.g. online handle, social media data, etc.).

The machine learning engine 146 may be one or more processing devices performing machine learning operations relative to the clip trigger detection and improving detection operations. For example, the machine learning engine may utilize existing open-source machine learning platforms operating in a cloud computing environment with one or more speech or audio recognition engines. In another example, where the clip trigger is a video clip trigger, the machine learning may utilize image or content recognition, including for example original content recognition (OCR).

FIG. 3 illustrates the machine learning engine 146 separate from the processing engine 102, but it is recognized that functionality described herein may be within the processing engine 102 of FIG. 2. The machine learning engine 146 operates at two phases, the first phase is detecting a clip trigger by monitoring the content feed for triggers and the second phase is processing feedback operations on existing segments to determine the accuracy of the first phase actions. In both phases, the engine 146 communicates with the trigger database 126, phase one to reference various clip triggers and phase two to improve the reliability of clip triggers stored therein.

In one embodiment, the machine learning environment learns directly from transmitted audio. By optimizing the algorithm in favor of false positives, the machine learning engine uses the feedback gathered from user dismissals specified as accidental triggers of unwanted clips to further train the neural network for accuracy and then mix labeled data with background noises recorded from several games and livestreams to further improve its accuracy. For example, in one embodiment after segment generation, the user can be presented with the dynamically generated segments. The user, via a user interface, can indicate if the segments are properly clipped, including indicating if the segment is a segment that the user would like to distribute and/or if the clip trigger detected by the processor was actual a clip trigger or a false detection.

The buffer 148 may be any suitable type of buffering system allowing for storing or buffering of the content feed during processing by the processing engine 102. For example, if the segments include content occurring thirty second before the audio trigger detection, the buffer may hold thirty seconds of content so the segment can be automatically generated. In another example, if the segment is generated after the full content feed is analyzed, the feed may be stored in the buffer 148 and segments extracted therefrom.

The transmitter 150 may be any suitable device for transmitting the segments or location identifiers in accordance with known transmission and distribution techniques.

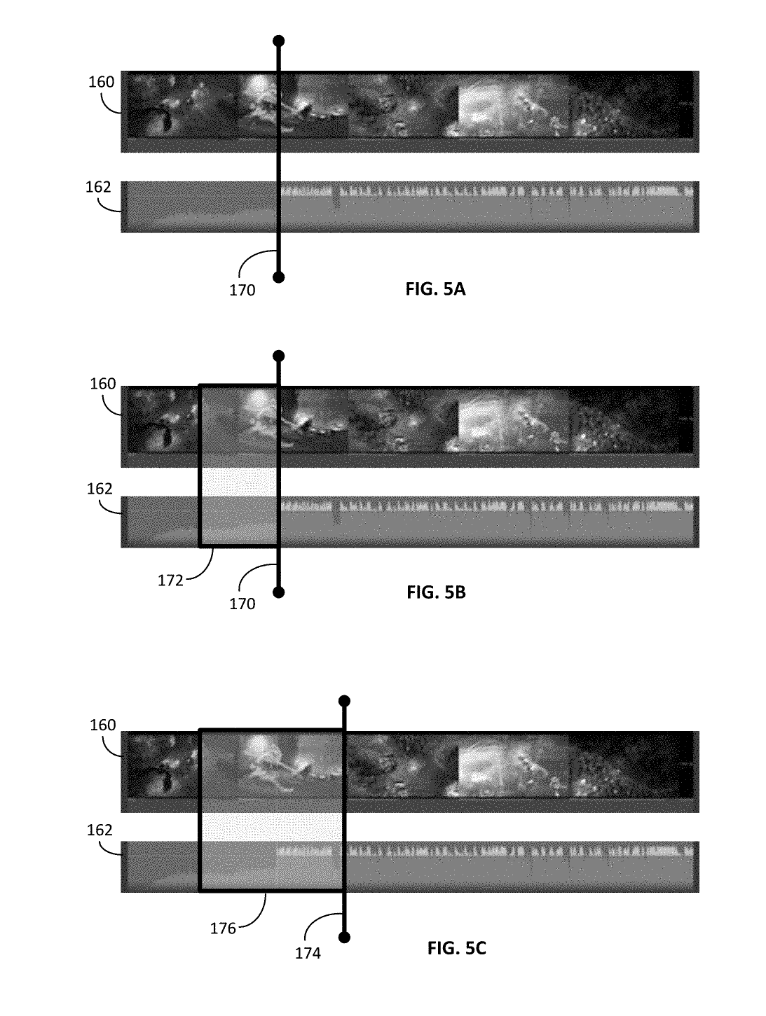

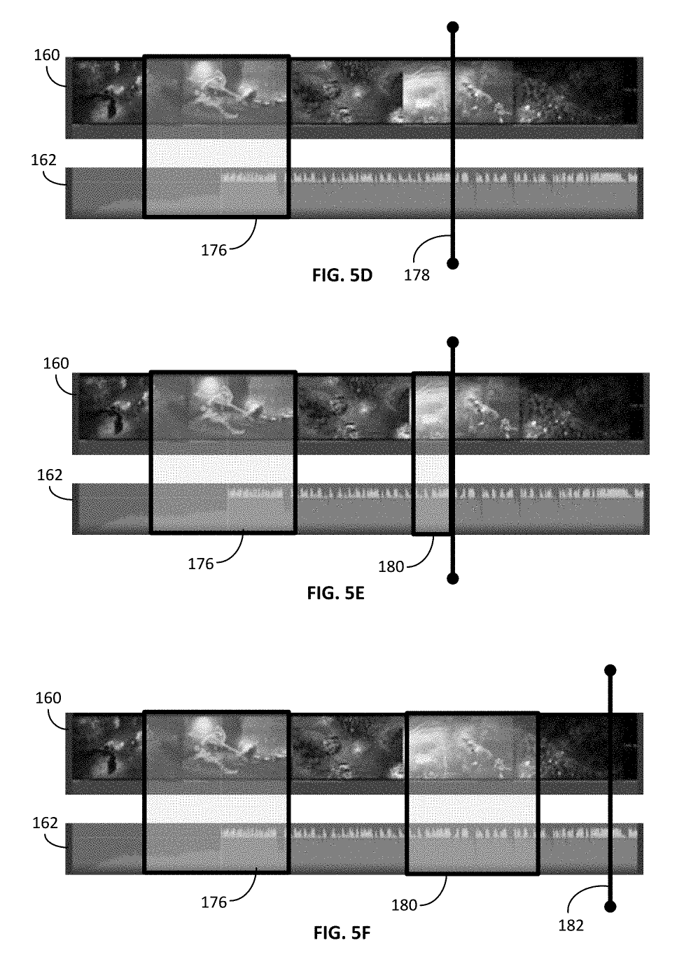

For further clarity, operations of the system 140 are described relative to the illustrative examples of the content feed in FIGS. 4, 5A-5E.

FIG. 4 illustrates a graphical representation of a content feed including a video feed 160 and an audio feed 162. The representation of the video feed 160 shows representative screenshots as the video images progress through the livestream. Concurrent, the audio feed 162 illustrates the corresponding audio accompanying the video track 160. As a timing marker passes down the feeds 160 and 162, a livestream output is the combination of video feed and audio feed. The processing engine 102, in combination with the clip engine 104 analyzes the audio feed 162 and/or video feed 160 and generates the segments from the combination of video feed 160 and audio feed 162.

It is further recognized that the processing engine 102, in detecting audio triggers, may ignore the video track 160. Therefore, the parser 144 may receive the content feed of FIG. 4, parse out the audio feed 162 and provide only this audio feed 162 to the processing engine 102.

FIGS. 5A-5E illustrate the segment generation using the audio feed 162. These figures including the video feed 160, but it is recognized the content feed segment may be determined solely with the audio feed and corresponding video feed segment integrated later. Moreover, the below-described segment generation uses the audio feed and an audio clip trigger, where it is recognized that the segment generation may utilize a video feed and a video clip trigger.

In FIG. 5A, the processing engine 102 analyses the audio feed 162 searching for an audio trigger. Upon detecting an audio trigger, the engine 102 notes the location on the audio feed 162, designated at point 170. In one example, it may be at this point the user could have stated instructions for generating a livestream segment.

Where one embodiment allows for including livestream content prior to the audio trigger, FIG. 5B illustrates a segment capture 172 extending back in time from the audio trigger point 170. In this exemplary embodiment, upon detecting the audio trigger at point 170, the system determines a segment beginning time, which can be at the point in time of the clip trigger or any earlier point in time.

As the livestream content feed continues to progress, the processing engine 102 determines a segment ending time, which is when to terminate the clipping. Varying embodiments may be utilized, including the processing engine 102 further listening to detect an instruction to terminate the segment, a predetermined time period after the audio trigger detection, an in-game sound that represents an appropriate segment termination point, etc. FIG. 5C illustrates that a later point in time 174 is designated along the audio feed, such that segment 176 incorporates time extending from the time before audio trigger detection to the termination point.

The processing engine 102 further monitors the audio feed for additional audio triggers. FIG. 5D illustrates the detection of a second trigger at point 178. FIG. 5E illustrates that beginning on the segment is then set at a time prior to the point 178, and the second segment 180 is being tracked. Upon segment termination, the processing engine 102 continues to monitor the audio feed 162, which may include further audio triggers, such as point 182.

In further embodiments, when overlapping periods are found, the processing engine 102 may decide to create two separate concurrent clips from the same livestream from different points in the stream, which may have overlapping periods

When segments are completed, the system 140 includes the clip engine 104 preparing the segment for electronic distribution. The clip engine 104 may include: formatting the content feed by integrating the video feed and audio feed; inserting video/audio data to the segment such as a intro screen, advertisement, outro screen, watermark or other visual or audio data; generating and/or inserting meta data or other descriptive data for association with the segment; etc.

When segments are ready for distribution, the clip engine 104 may therein operate with the transmitter 150 for electronic distribution. As noted above, the distribution may be across a proprietary or designated network or may be across a broader public network. The distribution may be a content feed or a location identifier for accessing the stored content.

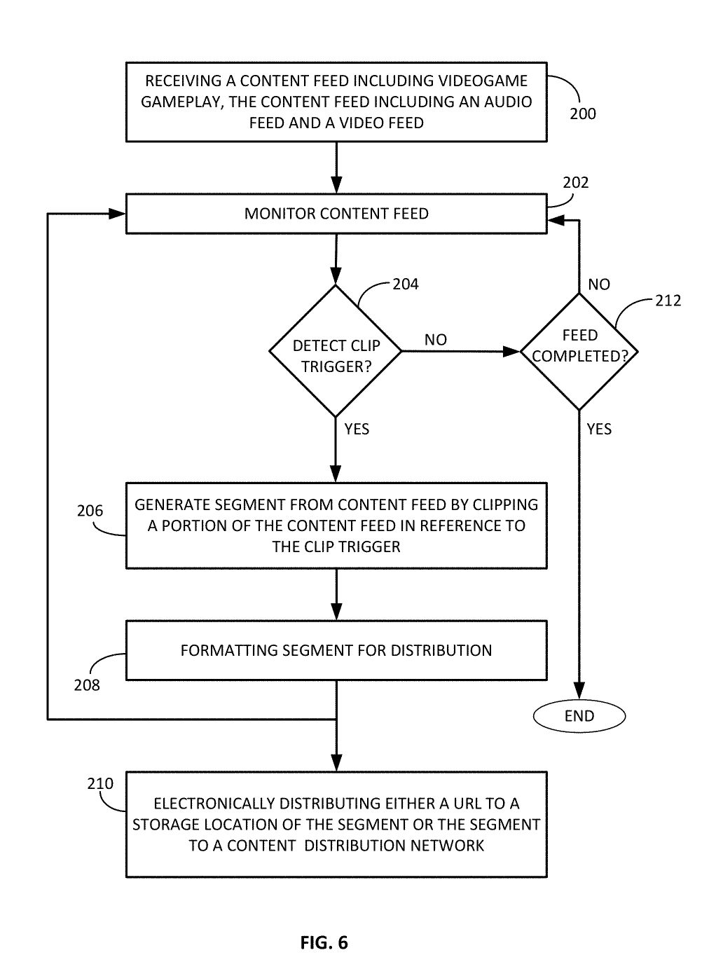

FIG. 6 illustrates a flowchart of the steps of one embodiment of a method for dynamic content clip generation and distribution. The methodology of FIG. 6 may be performed using the processing environment described above. In this method, a first step is receiving a content feed that includes an audio feed and a video feed, step 200. In one embodiment, the content feed is a feed of videogame gameplay.

Step 202 is to monitor the content feed. This includes processing the content feed for predetermined content that indicates a desire or an instruction for dynamic segment generation. This step 202 may be performed by the processing engine 102 in combination with the machine learning engine 146 in FIG. 3.

Step 204 is clip trigger detection. If detected, step 206 is generating a segment of the content feed by clipping a portion of the content feed relative to the clip trigger. In step 208, the method includes formatting the segment for electronic distribution. As noted above, the clip trigger relates to a detected trigger relative to the content fed being monitored, such as an audio trigger for monitoring an audio feed and a video trigger for monitoring a video feed.

With the segment formatted, step 210 provides for electronic distribution of either a URL identifying the segment or the segment itself. The electronic distribution is via a content distribution system.

In addition to the distribution, the method includes further monitoring the content audio feed, reverting back to step 202. In step 204, when an audio trigger is not detected, the method determines if the feed has been fully examined, step 212. If not, again the method reverts back to monitoring step 202 until the feed is fully reviewed. In step 212, if the feed is completed, the method terminates.

The above embodiments are described relative to a videogame gameplay livestream. It is recognized the present method and system can be utilized for any content feed having an audio feed and a video feed and is not expressly limited to videogames. For example, a content feed of a sporting event may include an audio trigger of a crowd roar or an announcer stating a specific phrase, e.g. Home Run. Whenever a content feed can be parsed into audio and video, the present method and system can therein analyze the content for dynamic segment generation as described above. In another embodiment, the content feed may be from a social media platform having videos or audio content available in its stream. For example, a user posting a video on Instagram®, that video, and its attendant audio, can be processed by the processing engine 102 for segment generation as described herein.

FIG. 7 illustrates another embodiment where the content feed is split between different processing locations. In the system, a user 102 engages the computer 122 performing processing operations that generate the content feed. In the gameplay example, the user may be playing a videogame, which generates a content feed including an audio feed of the gameplay audio and a video feed of the images.

The user 102 is connected to a communication platform 222, which may be any suitable network platform that allows for multiparty communication. In one example, the platform may be a game-related platform that enables multiple parties to communicate, including streaming content, such as Discord®. In this embodiment, the user 102 generates an audio content feed through the platform 222 by streaming an audio feed, such as the raw voice data of the user as they are speaking and playing a game. In another example, the audio content feed may be the audio feed generated by the game itself. A local processor on the computer 122 executes an application for segment generation as described herein.

The processing engine 102 can receive the audio feed from the communication platform 222 for detecting a clip trigger. The clip trigger detection operates using the trigger database 126 as described above. When a clip trigger is detected, the processing engine 102 can then send a clip generation command to the computing device 122 to generate the segment. The computer 122 may further provide for formatting the segment and enabling electronic distribution. Thus, in this embodiment, the application can be a thin-client application with detection operations performed on the network.

Therefore, content feed monitoring and segment generation does not need to be performed in a single processing environment. The method and system allows for individualized content feed monitoring and segment generation across a distributed environment.

The above embodiments are exemplary in nature. Further variations as recognized by one skilled in the art are within the scope herein. For example, the audio detection and clip generation is described using a livestream or a buffered content feed. Another embodiment may include analysis of the audio feed and designation of audio trigger points. For example, an audio trigger may be recognized at a point 1:42, with a backtrack period of thirty seconds, places a starting point at 1:12. The segment is then determined to be ninety seconds long, so the segment terminates at 2:42. This segment time marking may be used to then clip the livestream, pulling out the content feed segments from the 1:12 to 2:42 time period. In this embodiment, the content feed may not need to be fully loaded relative to the processing device, but rather the audio track can be sufficient for analysis, such as operating in low-bandwidth or bandwidth restricted processing environments.

Figures presented herein are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments.

1. A method for dynamic segment generation and distribution, the method comprising:
receiving within a computer processing device a livestream content feed from a livestream distribution system external to the computer processing device, the livestream content feed including videogame gameplay of a user playing a videogame, including an audio feed of user audio including in-game audio and user voice capture and a video feed of user gameplay of the videogame;
electronically monitoring the audio feed of the livestream content feed using the computer processing device to detect an audio clip trigger generated by the user, the audio clip trigger including an audible clip generation command for indicating generation of a segment, wherein the segment is a portion of the livestream content feed;
upon detection of the audio clip trigger, electronically generating using the computer processing device a segment from the livestream content feed by clipping a portion of the livestream content feed in reference to the audio clip trigger
formatting the segment; and
electronically distributing, via a networked connection, to a content distribution system external to the computer processing device, at least one of: a location identifier identifying the segment and the segment.

2. The method of claim 1, wherein the monitoring the content feed to detect the audio clip trigger comprises:
accessing a machine learning processing engine including a trigger detection database; and
detecting the audio clip trigger using the machine learning processing engine.

3. (canceled)

4. The method of claim 1, wherein the audio clip trigger is a user-generated voice command.

5. The method of claim 1, wherein the livestream content feed includes the video feed, the method further comprising:
electronically monitoring the video feed for a video clip trigger, the video clip trigger includes at least one of: a text display, a graphical display, and a visual element; and
upon detection of the video clip trigger, electronically generating a second segment from the livestream content feed by clipping a second portion of the livestream content feed in reference to the video clip trigger.

6. The method of claim 1, wherein clipping the segment comprises:
selecting a segment beginning time occurring a period of time prior to the audio clip trigger detection;
determining a segment ending time; and
extracting the content feed portion from the segment beginning time to the segment ending time to generate the segment.

7. The method of claim 6 further comprising:
determining the segment ending time by at least one of: recognizing an end-clip voice command, a predetermined time period, and a graphical display.

8. (canceled)

9. The method of claim 1 further comprising:
receiving user feedback regarding accuracy of the detection of the clip trigger; and
providing the feedback to a machine learning processing engine for updating a trigger detection database.

10. A system for dynamic segment generation and distribution, the system comprising:
a computer readable medium having executable instructions stored therein; and
a processing device, in response to the executable instructions, operative to:
receive a livestream content feed from a broadcast from a livestream distribution system external to the computer processing device, the livestream content feed including videogame gameplay of a user playing a videogame, the content feed including an audio feed of user audio including in-game audio and user voice capture and a video feed of user gameplay of the videogame;
electronically monitor audio feed of the livestream content feed to detect an audio clip trigger generated by the user, the audio clip trigger including an audible clip generation command for indicating generation of a segment, wherein the segment is a portion of the livestream content feed;
upon detection of the audio clip trigger, electronically generate a segment from the content feed by clipping a portion of the content feed in reference to the audio clip trigger;
format the segment; and
electronically distribute, via a networked connection, to a content distribution system external to the processing device, at least one of: a location identifier identifying the segment and the segment.

11. The system of claim 10, wherein the processing device in monitoring the content feed to detect the audio clip trigger is further operative to:
access a machine learning processing engine including a trigger detection database; and
detect the audio clip trigger using the machine learning processing engine.

12. (canceled)

13. The system of claim 10, wherein the audio clip trigger is a user-generated voice command.

14. The system of claim 10, wherein the livestream content feed includes the video feed, the processing device further operative to:
electronically monitor the video feed for a video clip trigger, the video clip trigger includes at least one of: a text display, a graphical display, and a triggering visual element; and
upon detection of the video clip trigger, electronically generate a second segment from the livestream content feed by clipping a second portion of the livestream content feed in reference to the video clip trigger.

15. The system of claim 10, wherein clipping the segment comprises:
selecting a segment beginning time occurring a first period of time prior to the detection of the audio clip trigger detection;
determining a segment ending time; and
extracting the content feed portion from the segment beginning time to the segment ending time to generate the segment.

16. The system of claim 15, the processing device further operative to:
determine the segment ending time by at least one of: recognizing an end-clip voice command, a predetermined time period, and a graphical display.

17. The system of claim 10, wherein the livestream content feed broadcasts from at least one of: a content feed generated in realtime; and a content feed being prior-generated and received from a storage location.

18. The system of claim 10, the processing device further operative to:
receive user feedback regarding accuracy of the detection of the clip trigger; and
provide the feedback to a machine learning processing engine for updating a trigger detection database.

19-20. (canceled)

21. The method of claim 4, the method further comprising:
extracting the user-generated voice command from the segment prior to electronic distribution.

22. The method of claim 6, wherein the selecting a segment beginning time occurring a period of time prior to the clip trigger detection further comprising:
receiving the period of time from the user via the audio clip trigger.

23. The system of claim 13, the processing device further operative to:
extract the user-generated voice command from the segment prior to electronic distribution.

24. The system of claim 15, wherein the selecting a segment beginning time occurring a period of time prior to the clip trigger detection is based on receiving the period of time from the user via the audio clip trigger.
